(19) United States
(12) Patent Application Publication
(10) Pub. No.: US 2004/0152427 A1
(43) Pub. Date: Aug. 5, 2004

(54) Single crystal oscillator RF transmitter system

(76) Inventors: Yen-Chang Chiu, Taipei (TW); Chong-Hao Tang, Tucheng City (TW); Ki-Dar Lin, Tanzih Township (TW); Ben-Chang Sun, Jhonghe City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/761,340

(22) Filed: Jan. 22, 2004

(30) Foreign Application Priority Data
Jan. 30, 2003 (TW) 092102446

(51) Int. Cl. H04B 1/40

(52) U.S. Cl. 455/85

(57) ABSTRACT

A single crystal oscillator RF transmitter system converts a data to be transmitted into RF packets by a converter under the control of a microprocessor, receives the RF packets and generates an RF signal accordingly to be sent out by a transmitter. The system comprises a local oscillator to generate a first clock in response to an external crystal to provide for the transmitter and connected to a clock switch which divides the frequency of the first clock so as to generate a second clock to the microprocessor and a third clock to the converter. Alternatively, an RC oscillator generates a fourth clock for the clock switch to provide the second and third clocks for the microprocessor and converter, respectively.

### FIELD OF THE INVENTION

The present invention relates generally to a wireless communications system, and more particularly, to a radio frequency (RF) transmitter system with single crystal oscillator.

### BACKGROUND OF THE INVENTION

The development aspects for household electric appliances have been directed toward the wireless communication protocol from the wired communication protocol in order for saving the wiring and convenient to use, since the technology of wireless communication transmission progresses further and further. For example, the communication protocol development for the peripheral equipment, such as computer mouse and keyboard, of personal computer (PC) system having been directed toward the wireless communication protocol, such as infrared ray (IR) and radio frequency (RF), from the conventional protocol, such as USB and PS/2, is a significant exemplification.

The data transmission of wireless communication protocol is necessarily completed by a transmitter system. In a typical transmitter system, the operations of the system, including encoding a data ready to be transmitted, converting the encoded data into predetermined RF packets, and sending the packet completely processed out by a transmitter, are controlled by a microprocessor. However, the frequency at which the data converter and the transmitter of the transmitter system operate is higher and thus different from the clock frequency of the microprocessor, and consequently, at least two sets of crystal oscillators are needed to generate two sets of different oscillating signals for providing as the master clock of the microprocessor and the carrier of the transmitter, respectively. Generally, in a conventional transmitter system, the frequency of the carrier of the transmitter is 27 MHz, while that of the master clock of the microprocessor is 4 MHz. Unfortunately, there are disadvantages including the cost being higher and two pins being necessarily provided on a chip for the connection of two crystal signals. Accordingly, there exists a need for a transmitter system to have a reduced number of crystal oscillators.

### SUMMARY OF THE INVENTION

It is an essential object of the present invention to propose a single crystal oscillator RF transmitter system for the purpose of reducing the cost.

It is another object of the present invention to propose an RF transmitter system capable of saving the power consumption thereof.

It is a further object of the present invention to propose an RF transmitter system capable of adjusting the master clock of the microprocessor thereof.

A single crystal oscillator RF transmitter system, according to the present invention, comprises a microprocessor, a converter connected to the microprocessor for the conversion of a data to be transmitted into RF packets, a local oscillator to generate a first clock in response to an external crystal, a clock switch connected to the first clock as well as providing a second clock for the microprocessor and a third clock for the converter, and a transmitter connected to the first clock and the RF packets, by which an RF signal is generated to be sent out.

A method, according to the present invention, for sending an RF signal to transmit a data by the operations of the inventive transmitter system, comprises generating the first clock in response to the external crystal to provide for the transmitter, generating the second and third clocks from the first clock to provide for the microprocessor and converter, respectively, converting the data into the RF packets by the converter to provide for the transmitter, and generating the RF signal to be sent by the transmitter.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a single crystal oscillator RF transmitter system chip according to the present invention; and

FIG. 2 shows another single crystal oscillator RF transmitter system chip according to the present invention.

### DETAILED DESCRIPTION OF THE INVENTION

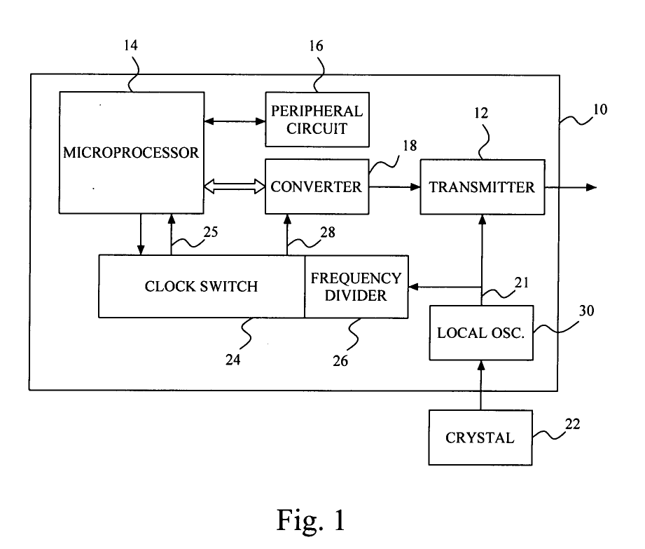

FIG. 1 shows a single chip RF transmitter system 10 according to the present invention, which comprises a microprocessor 14 to execute the core program of the chip 10 and control the operations of the chip 10, a peripheral circuit 16 connected to the microprocessor 14 that includes an analog-to-digital converter (ADC), a DC-to-DC converter, a pulse width modulator (PWM), and a plurality of input/output (I/O), a converter 18 connected to the microprocessor 14 to convert a data into RF packets by encoding specifically the data originated from the microprocessor 14 for a transmitter 12 to send out, a local oscillator 20 to generate a first clock 21 in responsive to an external crystal 22 to provide for the transmitter 12 as a carrier with the frequency of 27 MHz, a clock switch 24 including a frequency divider 26 connected with the first clock 21 for frequency dividing of the first clock 21 to generate oscillating signals with different frequencies, so as to provide a second clock 25 with the frequency of 4 MHz for the microprocessor 14 as the master clock, and a third clock 28 with the frequency of 100 kHz for the converter 18.

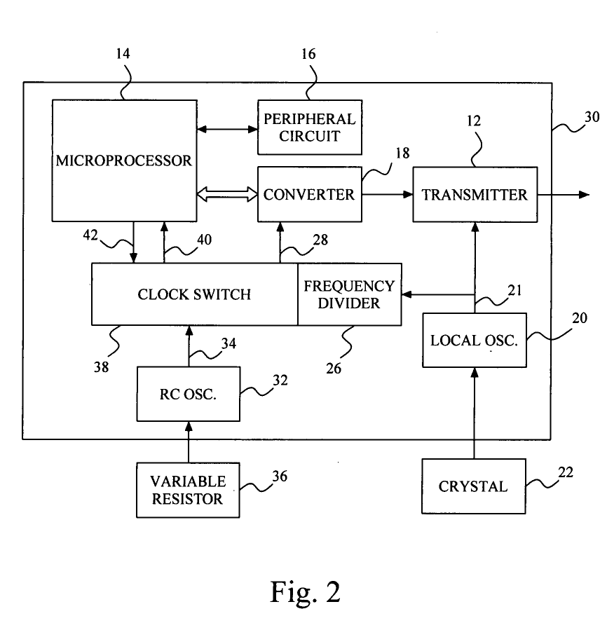

FIG. 2 shows another single chip RF transmitter system 30 according to the present invention, in which the transmitter 12, microprocessor 14, peripheral circuit 16, converter 18, and local oscillator 20 are identical to those of the chip 10 in the previous embodiment, except that the chip 30 further comprises an resistor-capacitor (RC) oscillator 32 to generate a second clock 34, the frequency of which is determined by adjusting an external variable resistor 36. Alternatively, the external variable resistor 36 is replaced with a resistor network built in the chip 30. As for a conventional resistor network, this resistor network is constructed by a plurality of resistors connected in parallel and in series, and its equivalent resistance is determined by the connections of fuses or switches. In addition, a clock switch 38 with the frequency divider 26 is connected with the first clock 21 and second clock 34. The first clock 21 is frequency-divided by the frequency divider 26 for generating the third clock 28 to provide for the converter 18, and a fourth clock 40 is generated by the clock switch 38 from the second clock 34 to provide for the microprocessor 14. In general, the third clock 28 is generated from the first clock 21 originated from the local oscillator 20, due to the fact that the converter 18 needs the more stable clock. For the converter 18 to operate, the microprocessor 14 sends a command 42 subsequently through the clock switch 38 to start up the local oscillator 20 to generate the first clock 21 and the frequency divider 26 to generate the third clock 28 from the first clock 21. After the RF packets are sent out completely by the transmitter 12, the local oscillator 20 is turned off and the transmitter 12 as well as the converter 18 are both shut-down by the command of the microprocessor 14, thereby saving the power consumption.

The cost of one set of crystal oscillator may be saved, since only the single external crystal 22 and the local oscillator 20 are necessary for generating the oscillating signals needed for the microprocessor 14, converter 18, and transmitter 12, or an additional RC oscillator 32 to provide the clock of the microprocessor 14 is added. If the external variable resistor 36 is not used, further reducing one pin of the chip will be obtained. Furthermore, due to the RC oscillator 32, it is convenient to adjust the frequency of the clock 34 and the cost thereof is lower than that of the crystal oscillator. Moreover, the electric power may be saved since the local oscillator 20 may be turned off after the packets transmission is completed.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claimed is:

1. A single crystal oscillator RF transmitter system comprising:
a microprocessor;
a converter for converting a data to be transmitted into RF packets;
a local oscillator responsive to an external crystal for generating a first clock;
a clock switch, connected with the first clock, for providing a second clock to the microprocessor and a third clock to the converter; and
a transmitter connected with the first clock and RF packets for generating an RF signal to be sent out.

2. The system of claim 1, wherein the clock switch comprises a frequency divider for frequency-dividing the first clock to generate the second clock.

3. The system of claim 1, wherein the clock switch comprises a frequency divider for frequency-dividing the first clock to generate the third clock.

4. The system of claim 1, further comprising an RC oscillator for generating the second clock.

5. The system of claim 4, wherein the clock switch comprises a frequency divider for frequency-dividing the first clock to generate the third clock.

6. The system of claim 4, wherein the RC oscillator is connected with an external resistor for tuning the second clock.

7. The system of claim 6, wherein the external resistor comprises a variable resistor.

8. The system of claim 4, wherein the RC oscillator comprises a resistor network for determining the second clock.

9. The system of claim 4, wherein the microprocessor signals the local oscillator to turn off after the RF signal is sent out.

10. The system of claim 4, wherein the converter and transmitter signal the local oscillator to turn off after the RF signal is sent out.

11. The system of claim 1, further comprising a peripheral circuit connected to the microprocessor.

12. The system of claim 1, wherein the microprocessor, converter, local oscillator, clock switch and transmitter are integrated on a chip.

13. The system of claim 4, wherein the microprocessor, converter, local oscillator, clock switch, RC oscillator and transmitter are integrated on a chip.

14. A method for transmitting a data by sending out an RF signal by a single crystal oscillator RF transmitter system including a microprocessor connected with a converter that is further connected to a transmitter, the method comprising the steps of:
generating a first clock responsive to the single crystal oscillator for providing to the transmitter;
generating a second clock and a third clock from the first clock for providing to the microprocessor and converter, respectively;
converting the data into RF packets by the converter for providing to the transmitter; and
generating the RF signal from the RF packets and sending out the RF signal by the transmitter.

15. The method of claim 14, wherein the step of generating a second clock and a third clock from the first clock comprises the step of frequency-dividing the first clock.

16. A method for transmitting a data by sending out an RF signal by a single crystal oscillator RF transmitter system including a microprocessor connected with a converter that is further connected to a transmitter, the method comprising the steps of:
generating a first clock by an RC oscillator;
generating a second clock from the first clock for providing to the microprocessor;
generating a third clock responsive to the single crystal oscillator;
generating a fourth clock from the third clock for providing to the converter;
converting the data into RF packets by the converter; and
receiving the RF packets and the first clock by the transmitter at which to generate the RF signal send out.

17. The method of claim 16, wherein the step of generating a fourth clock from the third clock comprises the step of frequency-dividing the third clock.

18. The method of claim 16, further comprising the step of tuning an external resistor connected to the RC oscillator for determining the first clock.

19. The method of claim 16, further comprising the step of trimming a built-in resistor network connected to the RC oscillator for determining the first clock.

20. The method of claim 16, further comprising the step of signaling the single crystal oscillator to stop generating the third clock after sending out the RF signal.

21. The method of claim 16, further comprising the step of signaling the converter to turn off after sending out the RF signal.

22. The method of claim 16, further comprising the step of signaling the transmitter to turn off after sending out the RF signal.
